(19) United States
(12) Patent Application Publication
(10) Pub. No.: US 2020/0055599 A1
(43) Pub. Date: Feb. 20, 2020

(54) UNMANNED AERIAL VEHICLE, UNMANNED AERIAL VEHICLE SYSTEM, AND BATTERY SYSTEM

(71) Applicant: Nidec Corporation, Kyoto (JP)

(72) Inventors: Yasumasa KODAIRA, Kyoto (JP); Masaki KATO, Kyoto (JP)

(21) Appl. No.: 16/609,786

(22) PCT Filed: Jun. 6, 2018
(86) PCT No.: PCT/JP2018/021663

§ 371 Date: Oct. 31, 2019

(30) Foreign Application Priority Data
Jun. 7, 2017 (JP) 2017-112644

(51) Int. Cl. B64C 39/02; H02J 7/02; H02J 50/10; H01F 38/14; B64D 27/24; B64F 1/36; B60L 53/122; B60L 53/126; H02J 50/40

(52) U.S. Cl. CPC B64C 39/024; H02J 50/80; H02J 50/10; H01F 38/14; B64D 27/24; B64F 1/362; B60L 53/122; B60L 53/126; H02J 50/40; B64C 2201/162; B64C 2201/108; B64C 2201/066; B64C 2201/027; B64C 2201/042; B60L 2200/10; H02J 7/025

(57) ABSTRACT

An unmanned aerial vehicle includes a main body, a propulsion assembly including a rotary blade and a motor to rotate the rotary blade about a rotation axis. The propulsion assembly is attached to the main body and further includes a rechargeable battery to supply electric power to the propulsion assembly, a frame portion surrounding an outside of the rotary blade in a radial direction, and a power receiving coil to provide non-contact power feeding. The power receiving coil is electrically connected to the battery, has a frame shape along the frame portion, and is provided in the frame portion.

### CROSS REFERENCE TO RELATED APPLICATIONS

This is a U.S. national stage of PCT Application No. PCT/JP2018/021663, filed on Jun. 6, 2018, and priority under 35 U.S.C. § 119(a) and 35 U.S.C. § 365(b) is claimed from Japanese Application No. 2017-112644, filed Jun. 7, 2017; the entire contents of each application are hereby incorporated herein by reference.

### 1. FIELD OF THE INVENTION

The present disclosure relates to an unmanned aerial vehicle, an unmanned aerial vehicle system, and a battery system.

### 2. BACKGROUND

A multicopter that flies by electric power supplied from a power feeding wire has been known. For example, a multicopter provided in an illumination system has been known.

### SUMMARY

One example embodiment of an unmanned aerial vehicle of the present disclosure includes a main body, a propulsion assembly including a rotary blade and a motor to rotate the rotary blade about a rotation axis, the propulsion assembly being to be attached to the main body, a rechargeable battery to supply electric power to the propulsion assembly, a frame portion in a frame shape surrounding an outside of the rotary blade in a radial direction of the rotation axis, and a power receiving coil to provide non-contact power feeding. The power receiving coil is electrically connected to the battery, and the power receiving coil has a frame shape along the frame portion and is provided in the frame portion.

One example embodiment of a battery system of the present disclosure provides a battery system of an unmanned aerial vehicle. The unmanned aerial vehicle includes a main body, a propulsion assembly including a rotary blade and a motor to rotate the rotary blade about a rotation axis, the propulsion assembly being to be attached to the main body, and a frame portion in a frame shape surrounding an outside of the rotary blade in a radial direction of the rotation axis. The battery system includes a rechargeable battery to supply electric power to the propulsion assembly, and a power receiving coil to provide non-contact power feeding. The power receiving coil is electrically connected to the battery, and the power receiving coil has a frame shape along the frame portion and is provided in the frame portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view showing an unmanned aerial vehicle system of the present example embodiment of the present disclosure.

FIG. 2 is a schematic diagram schematically showing the unmanned aerial vehicle system of the present example embodiment.

FIG. 3 is a diagram illustrating an example of a functional configuration of the unmanned aerial vehicle system of the present example embodiment.

FIG. 4 is a diagram of the unmanned aerial vehicle system of the present example embodiment as viewed from above.

FIG. 5 is a perspective view showing an unmanned aerial vehicle of the present example embodiment.

FIG. 6 is a diagram of the unmanned aerial vehicle of the present example embodiment as viewed along a depth direction.

FIG. 7 is a diagram showing the connection between a motor and a battery of the present example embodiment.

FIG. 8 is a perspective view showing an unmanned aerial vehicle system as another example of the present example embodiment.

FIG. 9 is a perspective view showing an unmanned aerial vehicle system as another example of the present example embodiment.

FIG. 10 is a diagram of an unmanned aerial vehicle system as another example of the present example embodiment as viewed from above.

FIG. 11 is an exploded perspective view showing a frame portion as another example of the present example embodiment.

FIG. 12 is a cross-sectional view showing a frame portion as another example of the present example embodiment.

### DETAILED DESCRIPTION

A Z-axis direction shown as appropriate in each drawing is a direction parallel to a vertical direction. The Z-axis direction is simply referred to as a “vertical direction Z”. The positive side in the Z-axis direction, that is, the upper side in the vertical direction is simply referred to as “upper side”, and the negative side in the Z-axis direction, that is, the lower side in the vertical direction is simply referred to as “lower side”. In addition, an X-axis direction and a Y-axis direction shown as appropriate in each drawing are orthogonal to the Z-axis direction and orthogonal to each other. The X-axis direction is referred to as a “depth direction X”, and the Y-axis direction is referred to as a “width direction Y”. The depth direction X corresponds to a first direction, and the width direction Y corresponds to a second direction. The depth direction and the width direction are merely names for describing a relative positional relationship of respective parts, and the actual arrangement relationship or the like may be an arrangement relationship or the like other than the arrangement relationship or the like indicated by these names.

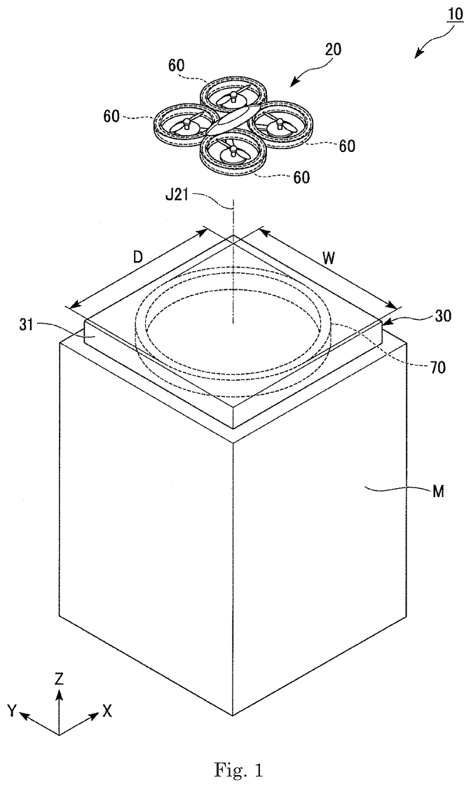

As shown in FIGS. 1 to 3, an unmanned aerial vehicle system 10 of the present example embodiment includes a power transmission device 30 and an unmanned aerial vehicle 20. In the present example embodiment, the power transmission device 30 is installed on an upper surface of a vending machine M, for example. The power transmission device 30 includes a power transmission device main body 31 and a power transmission coil 70. The power transmission device main body 31 has, for example, a rectangular parallelepiped shape that is flat in the vertical direction Z.

As shown in FIG. 1, the power transmission coil 70 has an annular shape centering on a second central axis J21 parallel to the vertical direction Z. The power transmission coil 70 is embedded in the power transmission device main body 31. The power transmission coil 70 is a non-contact power feeding coil capable of transmitting power to a power receiving coil 60 described later. In the present example embodiment, in the power transmission coil 70, a dimension D in the depth direction X orthogonal to the second central axis J21 of the power transmission coil 70 is 648 mm or smaller, and a dimension W in the width direction Y orthogonal to both the second central axis J21 and the depth direction X of the power transmission coil 70 is 870 mm or smaller.

Here, in a typical standard of the vending machine M, for example, the dimension in the depth direction X of the vending machine M is 648 mm or larger and 819 mm or smaller, and the dimension in the width direction Y of the vending machine M is 870 mm or larger and 1378 mm or smaller. Therefore, by setting the dimension D and dimension W of the power transmission coil 70 within the above numerical range, the power transmission coil 70 is installable on the upper surface of the vending machine M in any vending machine M as long as it conforms to the typical standard. Note that the dimension D of the power transmission coil 70 may be larger than 648 mm and the dimension W of the power transmission coil 70 may be larger than 870 mm as long as it is within the dimension range of the typical standard of the vending machine M described above.

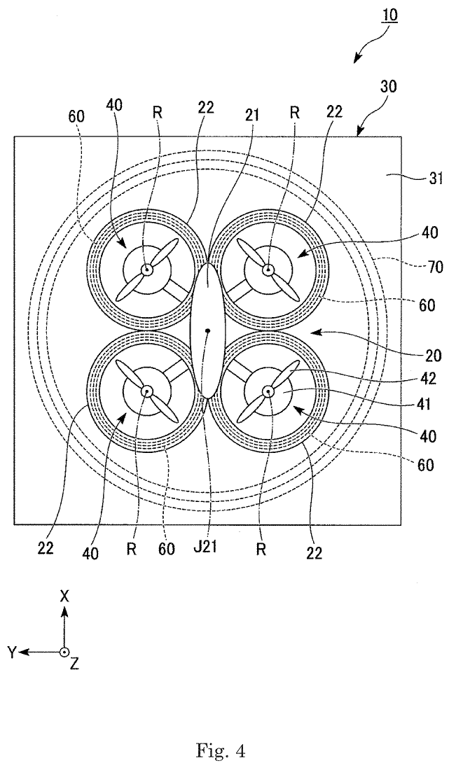

As shown in FIG. 4, in the present example embodiment, the outer diameter of the power transmission coil 70 is equal to or larger than the maximum dimension of the unmanned aerial vehicle 20. Therefore, when the unmanned aerial vehicle 20 lands on the upper surface of the power transmission device main body 31, the entire unmanned aerial vehicle 20 can be disposed inside the outer edge of the power transmission coil 70 as viewed from above. In the present description, the “maximum dimension of the unmanned aerial vehicle” includes the length of a longest virtual line segment among the virtual line segments connecting two arbitrary points in the unmanned aerial vehicle. In the present example embodiment, for example, in the case where the unmanned aerial vehicle 20 is in the orientation shown in FIG. 4, a dimension on the unmanned aerial vehicle 20 in the direction orthogonal to the vertical direction Z and intersecting both the depth direction X and the width direction Y at an angle of 45° is the maximum dimension of the unmanned aerial vehicle 20.

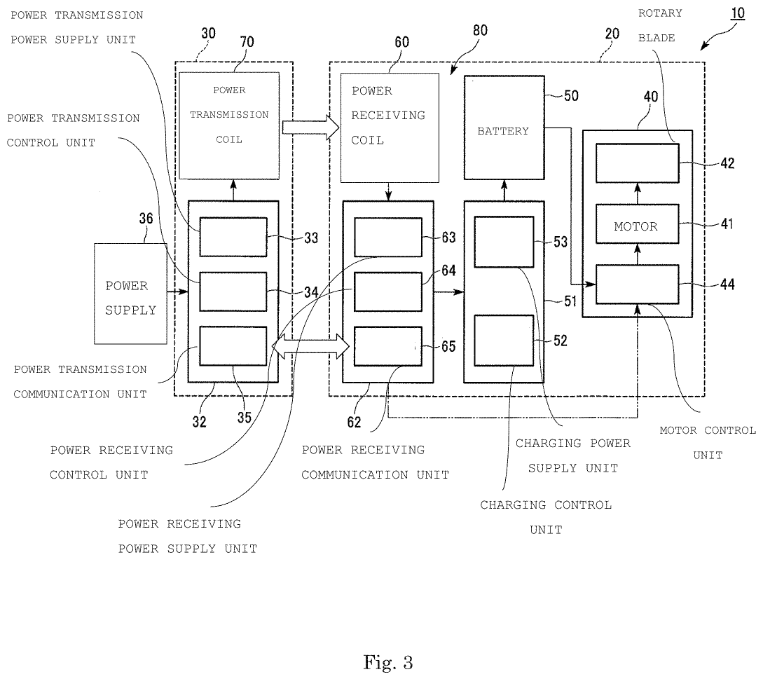

As illustrated in FIG. 3, the power transmission device 30 further includes a power transmission unit 32. Electric power is supplied 32 from an external power supply 36 to the power transmission unit. The power supply 36 may be a DC power supply or an AC power supply such as a commercial power supply. The power transmission unit 32 includes a power transmission power supply unit 33, a power transmission communication unit 35, and a power transmission control unit 34.

The power transmission power supply unit 33 outputs electric power supplied from the power supply 36 to the power transmission coil 70 based on the control by the power transmission control unit 34. The power transmission communication unit 35 includes, for example, an infrared sensor or the like, and receives infrared light for communication emitted from a power receiving communication unit 65, described later, provided to the unmanned aerial vehicle 20. The power transmission communication unit 35 may emit infrared light for communication to the power receiving communication unit 65 of the unmanned aerial vehicle 20. The power transmission control unit 34 controls power supply by the power transmission coil 70 based on the infrared light received by the power transmission communication unit 35.

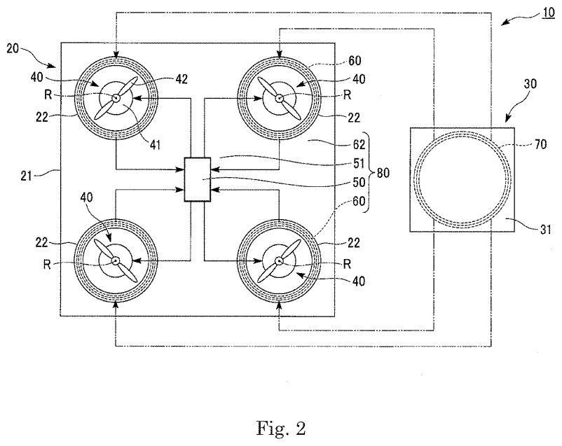

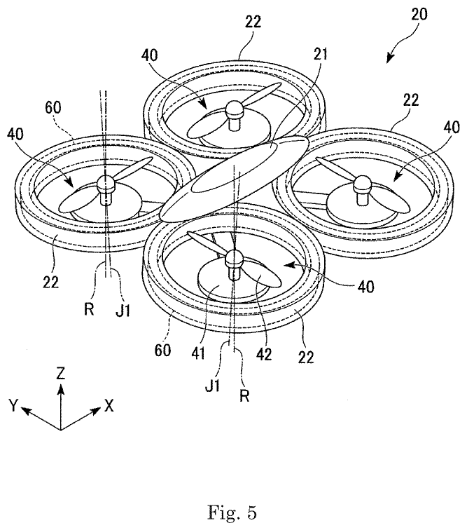

As shown in FIGS. 2 to 5, the unmanned aerial vehicle 20 includes a main body 21, a propulsion assembly 40, a battery 50, a frame portion 22, and a power receiving coil 60. The main body 21 extends in a predetermined direction. In the following description, the relative positional relationship of the respective parts of the unmanned aerial vehicle 20 will be described for the case where the predetermined direction in which the main body 21 extends is parallel to the depth direction X as shown in FIGS. 4 and 5 unless otherwise specified.

The propulsion assembly 40 is attached to the main body 21. In the present example embodiment, a plurality of the propulsion assemblies 40 are provided. For example, four propulsion assemblies 40 in total are provided side by side in the depth direction X, two on each side of the main body 21 in the width direction Y. The propulsion assembly 40 includes a motor 41 and rotary blades 42. The motor 41 is disposed at the tip of an arm portion that extends from the main body 21. The rotary blade 42 is fixed to the shaft of the motor 41. The motor 41 rotates the shaft to thereby rotate the rotary blades 42 about a rotation axis R. In the present example embodiment, the rotation axis R extends in the vertical direction Z. As the rotary blades 42 rotate, the unmanned aerial vehicle 20 obtains buoyancy from the propulsion assembly 40 and also obtains propulsion in a direction orthogonal to the vertical direction Z. As shown in FIG. 3, the propulsion assembly 40 further includes a motor control unit 44. The motor control unit 44 outputs the electric power, supplied from the battery 50, to the motor 41 based on information from a flight control unit not shown.

As shown in FIG. 2, the battery 50 is a rechargeable battery disposed in the main body 21. The battery 50 is electrically connected to the propulsion assembly 40 and supplies electric power to the propulsion assembly 40. In the present example embodiment, for example, one battery 50 is provided. The one battery 50 is electrically connected to the plurality of propulsion assemblies 40 and supplies electric power to the plurality of propulsion assemblies 40. The type of the battery 50 is not particularly limited as long as it is a rechargeable battery.

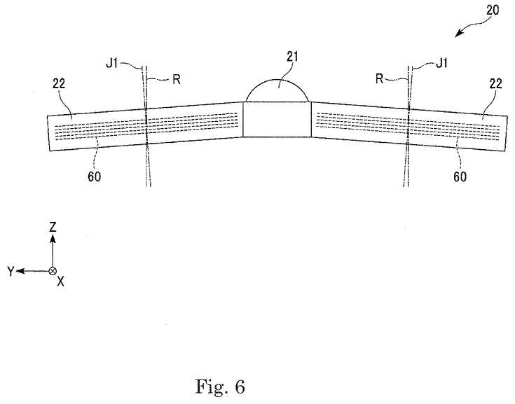

The frame portion 22 has a frame shape surrounding the outside of the rotary blade 42 in the radial direction of the rotation axis R. More specifically, the frame portion 22 has an annular shape centering on a first central axis J1. As shown in FIGS. 5 and 6, the first central axis J1 is inclined with respect to the vertical direction Z. That is, the first central axis J1 is inclined with respect to the rotation axis R. As shown in FIG. 6, the first central axis J1 is inclined with respect to the vertical direction Z toward the side away from the main body 21 in the width direction Y as it goes from the lower side to the upper side. In the present example embodiment, the frame portion 22 is provided for each of the plurality of propulsion assemblies 40. That is, as shown in FIGS. 4 and 5, for example, four frame portions 22 are provided side by side in total in the depth direction X, two on each side in the width direction Y of the main body 21. The frame portion 22 is fixed to the main body 21. In the present example embodiment, the frame portion 22 is, for example, a single member with the main body 21. The main body 21 and the frame portion 22 are made of a resin such as polystyrene foam, for example.

The frame portion 22 is provided, for example, to protect the rotary blades 42 and to suitably guide the air flow generated by the rotary blades 42 along the inner peripheral surface of the frame portion 22. In the present example embodiment, since the frame portion 22 has an annular shape, it is easy to obtain these functions more suitably.

The power receiving coil 60 is a coil for non-contact power feeding. As shown in FIG. 2, the power receiving coil 60 is electrically connected to the battery 50. When a magnetic field generated by the electric current flowing through the power transmission coil 70 acts on the power receiving coil 60, the electric current flows through the power receiving coil 60. Thus, power can be supplied from the power receiving coil 60 to the battery 50, and the battery 50 can be charged. Therefore, by bringing the unmanned aerial vehicle 20 closer to the power transmission device 30, non-contact power feeding can be performed by the power receiving coil 60 and the power transmission coil 70 without connecting the battery 50 to an external power supply. Further, since non-contact power feeding can be performed by the power receiving coil 60 and the power transmission coil 70, the structure of the unmanned aerial vehicle 20 and the structure of the power transmission device 30 can be simplified. As described above, charging of the battery 50 can be automated with a simple structure and control.

Further, for example, when the unmanned aerial vehicle is automatically moved to connect the battery and an external power supply, a terminal for connecting the battery and the external power supply may be exposed to the outside. For this reason, when the power transmission device is installed outdoors, the terminal may get wet with rain, which may cause a problem in charging the battery. On the other hand, according to the present example embodiment, since it is not necessary to connect the battery 50 to an external power supply, it is not necessary to expose the terminal to the outside. Therefore, even if the power transmission device 30 is installed outdoors, the battery 50 can be suitably charged. Further, since the charging of the battery 50 can be automated, the battery 50 can be charged if the unmanned aerial vehicle 20 is movable even in a place where it is difficult for a person to enter.

The power receiving coil 60 has a frame shape along the frame portion 22, and is provided to the frame portion 22. Therefore, it is not necessary to separately provide a part where the power receiving coil 60 is provided, and the unmanned aerial vehicle 20 can be reduced in size and weight. Further, it is not necessary to change the shape of the unmanned aerial vehicle 20. In the present example embodiment, since the rotation axis R extends in the vertical direction Z, the frame portion 22 surrounding the outside of the rotary blade 42 in the radial direction of the rotation axis R is provided substantially along a plane orthogonal to the vertical direction Z. Thereby, the power receiving coil 60 provided to the frame portion 22 can be provided substantially along a plane orthogonal to the vertical direction Z. Therefore, when the unmanned aerial vehicle 20 lands, the entire power receiving coil 60 can be easily brought close to the surface on which the unmanned aerial vehicle 20 has landed. Therefore, by disposing the power transmission coil 70 on the lower side of the surface on which the unmanned aerial vehicle 20 has landed, the power receiving coil 60 and the power transmission coil 70 can be easily brought close to each other, and electric current can be easily generated in the power receiving coil 60. Therefore, it is easy to supply electric power to the battery 50, and it is easier to charge the battery 50.

Specifically, in the case of the power transmission device 30 as shown in FIG. 1, the entire power receiving coil 60 can be brought closer to the upper surface of the power transmission device main body 31 when the unmanned aerial vehicle 20 is caused to land on the upper surface of the power transmission device main body 31. Thereby, the entire power receiving coil 60 can be brought close to the power transmission coil 70 embedded in the power transmission device main body 31. Therefore, it is easier to charge the battery 50.

In the present example embodiment, the power receiving coil 60 and the power transmission coil 70 are coils for non-contact power feeding by a magnetic field resonance system. In the case of using non-contact power feeding by the magnetic field resonance system, when the power receiving coil 60 is brought close to the power transmission coil 70, electric current can be generated in the power receiving coil 60 regardless of the relative orientation between the power receiving coil 60 and the power transmission coil 70. Therefore, it is easy to charge the battery 50 regardless of the orientation of the unmanned aerial vehicle 20 with respect to the power transmission device 30 and the orientation of the power receiving coil 60 with respect to the unmanned aerial vehicle 20. Thus, even when the position control accuracy of the unmanned aerial vehicle 20 is relatively low, it is possible to easily charge the battery 50 by simply bringing the unmanned aerial vehicle 20 closer to the power transmission device 30. Therefore, the battery 50 can be automatically charged by simpler control of the unmanned aerial vehicle 20.

As shown in FIG. 5, in the present example embodiment, the power receiving coil 60 has an annular shape centering on the first central axis J1. That is, the first central axis J1 of the power receiving coil 60 is inclined with respect to the vertical direction Z. Therefore, when the unmanned aerial vehicle 20 lands on the upper surface of the power transmission device main body 31, the first central axis J1 of the power receiving coil 60 is inclined with respect to the second central axis J21 of the power transmission coil 70. In the present example embodiment, since non-contact power feeding by the magnetic field resonance system is employed, the battery 50 can be charged even when the power receiving coil 60 and the power transmission coil 70 are inclined with respect to each other.

Further, even when the frame portion 22 is provided to be inclined as in the present example embodiment, it is possible to easily charge the battery 50 as described above by simply providing the power receiving coil 60 along the frame portion 22. That is, it is possible to easily charge the battery 50 with the power receiving coil 60 being provided to the frame portion 22, without changing the inclination of the frame portion 22 with respect to the main body 21. Accordingly, charging of the battery 50 can be automated with a simple structure and control, without impairing the function of the frame portion 22. Specifically, the power receiving coil 60 can be mounted on the unmanned aerial vehicle 20, while the air flow generated by the rotary blades 42 guided by the inner peripheral surface of the frame portion 22 is maintained suitably. Therefore, the flight performance of the unmanned aerial vehicle 20 can be suitably maintained.

In the present example embodiment, the power receiving coil 60 is embedded in the frame portion 22. Therefore, the frame portion 22 can be made by insert molding in which resin is poured in a state where the power receiving coil 60 is inserted into the mold. Accordingly, the unmanned aerial vehicle 20 can be easily manufactured.

The power receiving coil 60 is provided to each of the plurality of frame portions 22. Therefore, the battery 50 can be charged by the electric current generated in the plurality of power receiving coils 60. In the present example embodiment, as shown in FIG. 2, the plurality of power receiving coils 60 are electrically connected to one battery 50, so that one battery 50 can be charged by the electric current generated in the plurality of power receiving coils 60. Therefore, the battery 50 can be charged more quickly.

As shown in FIG. 4, the outer diameter of the power receiving coil 60 is smaller than the outer diameter of the power transmission coil 70. Therefore, when the unmanned aerial vehicle 20 is brought close to the power transmission device 30, the power receiving coil 60 is easily placed in the magnetic field generated by the power transmission coil 70, and electric current is easily generated in the power receiving coil 60. Further, as described above, since the outer diameter of the power transmission coil 70 is equal to or larger than the maximum dimension of the unmanned aerial vehicle 20, the entire unmanned aerial vehicle 20 can be disposed inside the outer edge of the power transmission coil 70 as viewed from above. Therefore, all of the plurality of power receiving coils 60 can be disposed inside the outer edge of one power transmission coil 70, and electric current can be generated in all of the plurality of power receiving coils 60 by one power transmission coil 70. Therefore, it is not necessary to provide a plurality of power transmission coils 70, and the structure of the power transmission device 30 can be simplified. In addition, since electric current can be generated in all of the power receiving coils 60 simultaneously, the battery 50 can be charged more quickly.

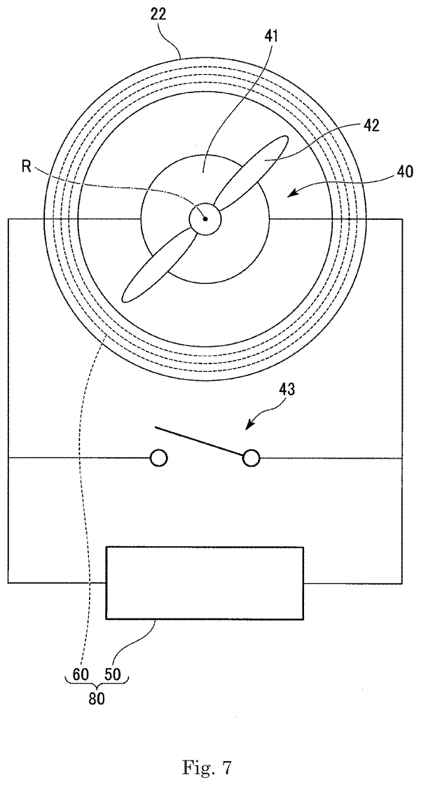

As shown in FIG. 7, the unmanned aerial vehicle 20 further includes a switching circuit 43. The switching circuit 43 is provided between two wires that connect the two terminals of the battery 50 and the two terminals of the motor 41, respectively. The switching circuit 43 connects the two wires in the ON state. As a result, the switching circuit 43 connects the terminals of the motor 41 and short-circuits them in the ON state. Therefore, turning the switching circuit 43 on can prevent the motor 41 from rotating. Thereby, when the motor 41 is stopped and the battery 50 is charged, it is possible to suppress the motor 41 from malfunctioning due to the magnetic field generated by the power transmission coil 70.

As shown in FIG. 3, the unmanned aerial vehicle 20 further includes a power receiving unit 62 and a battery control unit 51. The power receiving unit 62 includes a power receiving power supply unit 63, a power receiving communication unit 65, and a power receiving control unit 64. The power receiving power supply unit 63 outputs electric power supplied from the power receiving coil 60 to the battery control unit 51 based on the control by the power receiving control unit 64. The power receiving communication unit 65 includes, for example, a light source that emits infrared light or the like for communication, and emits infrared light based on the control by the power receiving control unit 64. The power receiving communication unit 65 receives infrared light emitted from the power transmission communication unit 35.

The power receiving control unit 64 controls the power receiving communication unit 65. Specifically, the power receiving control unit 64 outputs a power supply start request signal and a power supply stop request signal to the power receiving communication unit 65. The power receiving communication unit 65 transmits the power supply start request signal and the power supply stop request signal, output from the power receiving control unit 64, to the power transmission device 30.

The battery control unit 51 includes a charging power supply unit 53 and a charging control unit 52. The charging power supply unit 53 outputs the electric power supplied from the power receiving unit 62 to the battery 50 based on the control by the charging control unit 52. The charging control unit 52 controls the start and stop of charging of the battery 50.

In the present example embodiment, the battery 50, the power receiving coil 60, the power receiving unit 62, and the battery control unit 51 constitute a battery system 80. That is, the battery system 80 includes the battery 50, the power receiving coil 60, the power receiving unit 62, and the battery control unit 51.

The present disclosure is not limited to the above-described example embodiment, and other configurations described below can also be adopted. The rotation axis R on which the rotary blade 42 rotates may extend in a direction other than the vertical direction Z. For example, the rotation axis R may extend in a direction orthogonal to the vertical direction Z. Further, the extending directions of the rotation axes R in the plurality of rotary blades 42 may be different from each other. Further, the number of propulsion assemblies 40 is not particularly limited. In addition to the propulsion assembly 40 in which the rotary blades 42 are surrounded by the frame portion 22, for example, another propulsion assembly in which the rotary blades are not surrounded by the frame portion may be provided.

Further, the power receiving coil 60 may be provided only to some frame portions 22 of the plurality of frame portions 22. The shape of the frame portion 22, the shape of the power receiving coil 60, and the shape of the power transmission coil 70 are not particularly limited, and may be a rectangular shape, a polygonal shape, or an elliptical shape. The shape of the power receiving coil 60 and the shape of the power transmission coil 70 may be different from each other. The first central axis J1 of the power receiving coil 60 may be parallel to the vertical direction Z. Further, the number of power receiving coils 60 mounted on the unmanned aerial vehicle 20 is not particularly limited.

Further, a plurality of batteries 50 may be provided. In this case, the power receiving coil 60 may be connected to each of the plurality of batteries 50 one by one, or a plurality of power receiving coils 60 may be connected to each other. The battery 50 may be provided for each propulsion assembly 40. Further, the switching circuit 43 may not be provided.

Further, the power receiving coil 60 and the power transmission coil 70 may be non-contact power feeding coils of a system other than the magnetic field resonance system. The power receiving coil 60 and the power transmission coil 70 may be, for example, electromagnetic induction type non-contact power feeding coils or radio wave reception type non-contact power feeding coils. Note that the outer shape of the power receiving coil 60 and the power transmission coil 70 is not limited to a circular shape. For example, the outer shape of the power receiving coil 60 and the power transmission coil 70 may be elliptical, rectangular, or the like, or may be a solenoid type.

In the magnetic field resonance system, power can be supplied even if the power receiving coil 60 and the power transmission coil 70 are misaligned. Therefore, even when the power receiving coil 60 is positioned outside the outer edge of the power transmission coil 70, power can be supplied. The unmanned aerial vehicle does not necessarily have to land within the outer edge of the power transmission coil 70.

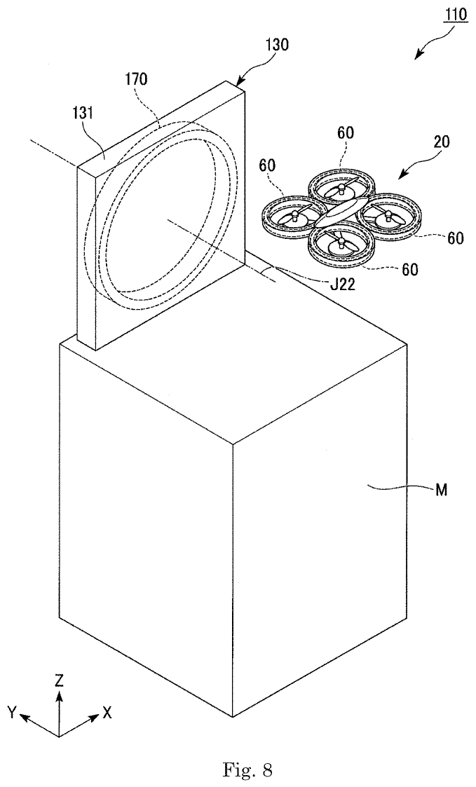

Further, the power transmission device 30 may have a configuration similar to that of a power transmission device 130 shown in FIG. 8. As shown in FIG. 8, in an unmanned aerial vehicle system 110, a power transmission device main body 131 of the power transmission device 130 has, for example, a rectangular parallelepiped shape that is flat in the width direction Y. The power transmission device main body 131 is disposed at the end on one side in the width direction on the upper surface of a vending machine M. A power transmission coil 170 has an annular shape centering on a second central axis J22 parallel to the width direction Y. In this configuration, the first central axis J1 of the power receiving coil 60 of the unmanned aerial vehicle 20 and the second central axis J22 of the power transmission coil 170 are substantially orthogonal. Even in this case, by using non-contact power feeding of the magnetic field resonance system, it is possible to charge the battery 50 by generating electric current in the power receiving coil 60. In the power transmission device 130, for example, the power transmission device 30 shown in FIG. 1 is rotated by 90° about an axis parallel to the depth direction X.

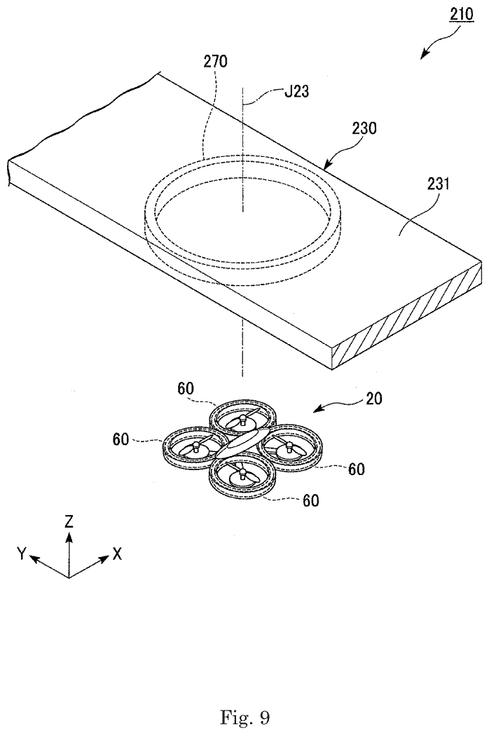

Further, the power transmission device 30 may be configured as a power transmission device 230 shown in FIG. 9. As shown in FIG. 9, in an unmanned aerial vehicle system 210, a power transmission device main body 231 of the power transmission device 230 is, for example, a part of the ceiling. That is, a power transmission coil 270 is embedded in the ceiling. The power transmission coil 270 has an annular shape centering on a second central axis J23 parallel to the vertical direction Z. The unmanned aerial vehicle 20 approaches the power transmission coil 270 from below and charges the battery 50. In this configuration, the unmanned aerial vehicle 20 rotates the rotary blades 42 by the motor 41 and charges the battery 50 in a flying state. Therefore, in this configuration, the unmanned aerial vehicle 20 charges the battery 50 with the switching circuit 43 in the OFF state. Note that the power transmission device main body 231 may be a member fixed to the ceiling instead of a part of the ceiling.

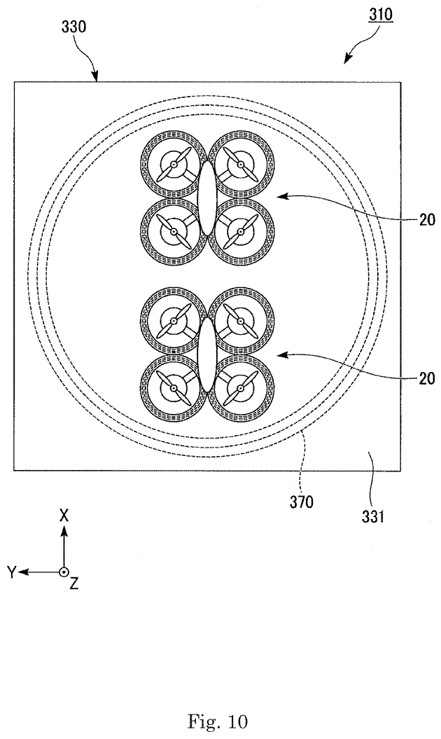

Further, the power transmission device 30 has a configuration similar to that of a power transmission device 330 shown in FIG. 10. As shown in FIG. 10, in an unmanned aerial vehicle system 310, the outer diameter of a power transmission coil 370 of the power transmission device 330 is at least twice as large as the maximum dimension of the unmanned aerial vehicle 20. Therefore, it is easy to dispose a plurality of unmanned aerial vehicles 20 simultaneously inside the outer edge of the power transmission coil 370, and power can be supplied to the plurality of unmanned aerial vehicles 20 simultaneously. In FIG. 10, when two unmanned aerial vehicles 20 land on the upper surface of the power transmission device main body 331, it is desirable that the two unmanned aerial vehicles 20 as a whole are disposed inside the outer edge of the power transmission coil 370 when viewed from above.

Further, the outer diameter of the power transmission coil 70 of the power transmission device 30 may be smaller than the maximum dimension of the unmanned aerial vehicle 20. Even in this case, for example, if the plurality of power receiving coils 60 can be opposed to the power transmission coil 70, the batteries 50 can be charged by simultaneously generating electric currents for the plurality of power receiving coils 60. Further, the installation location of the power transmission device 30 is not particularly limited. The dimensions of the power transmission coil 70 can be appropriately determined according to the installation location of the power transmission device 30. Part or whole of the power transmission coil 70 may be exposed from the power transmission device main body 31.

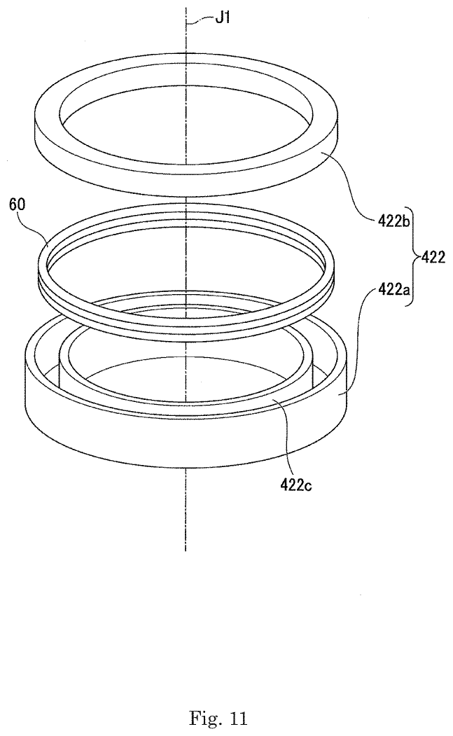

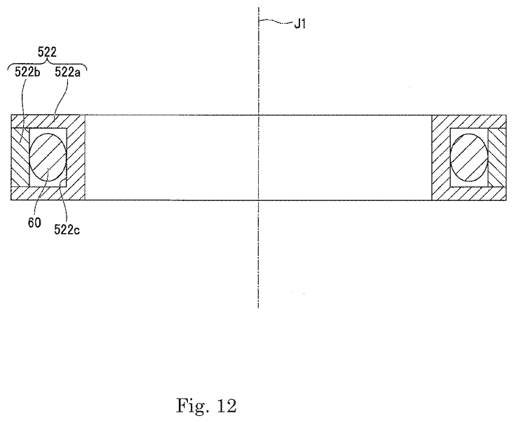

Further, the frame portion 22 may have a configuration like a frame portion as shown in FIGS. 11 and 12. A frame portion 422 shown in FIG. 11 has a frame main body 422a and a lid part 422b. The frame main body 422a has an annular shape centering on the first central axis J1. The frame main body 422a has a groove 422c that opens in one direction and accommodates the power receiving coil 60. One direction in which the groove 422c opens is a direction parallel to the axial direction of the first central axis J1. In FIG. 11, the groove 422c opens upward. The lid part 422b has an annular shape centering on the first central axis J1. The lid part 422b is fitted into and fixed to the opening of the groove 422c. Thereby, the lid part 422b is fixed to the frame main body 422a, and closes the opening of the groove 422c. According to this configuration, the power receiving coil 60 can be easily replaced by making the lid part 422b detachable.

A frame main body 522a of a frame portion 522 shown in FIG. 12 differs from the frame portion 422 shown in FIG. 11 in the direction in which a groove 522c opens. One direction in which the groove 522c opens is the radial direction of the first central axis J1. In FIG. 12, the groove 522c opens outward in the radial direction of the first central axis J1. The lid part 522b is fitted into the groove 522c from the radially outer side and fixed to the frame main body 522a. According to this configuration, similar to the frame portion 422 shown in FIG. 11, the power receiving coil 60 can be easily replaced by making the lid part 522b detachable. Further, in the case of the configuration shown in FIGS. 11 and 12, it is easy to replace the battery system 80 including the battery 50 and the power receiving coil 60.

Further, the power transmission communication unit 35 and the power receiving communication unit 65 may perform communication at all times or at predetermined intervals. The power receiving unit 62 may receive power receiving state information indicating a state of power receiving by the power receiving coil 60 from the power transmission communication unit 35. Note that the power transmission communication unit 35 and the power receiving communication unit 65 are not limited to adopt the system using infrared light, and other systems such as wireless communication may be adopted. The unmanned aerial vehicle 20 performs horizontal movement or rotational movement based on the power receiving state information received by the power receiving communication unit 65. That is, the motor control unit 44 controls the motor 41 based on the power receiving state information indicating the state of power receiving by the power receiving coil 60, whereby the unmanned aerial vehicle 20 moves.

Further, as indicated by a two-dot chain line in FIG. 3, the power receiving unit 62 may be directly connected to the motor control unit 44. In this configuration, electric power is directly supplied from the power receiving unit 62 to the motor control unit 44. In this configuration, the power receiving control unit 64 may determine whether to supply electric power from the battery 50 to the motor control unit 44 or to supply electric power from the power receiving unit 62 to the motor control unit 44, for example.

Moreover, the use of the unmanned aerial vehicle and the unmanned aerial vehicle system of the above-described example embodiment is not particularly limited. Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-14: (canceled)

15: An unmanned aerial vehicle comprising:
a main body;
a propulsion assembly including a rotary blade and a motor to rotate the rotary blade about a rotation axis, the propulsion assembly being attached to the main body;
a rechargeable battery to supply electric power to the propulsion assembly;
a frame portion in a frame shape surrounding an outside of the rotary blade in a radial direction of the rotation axis; and
a power receiving coil to provide non-contact power feeding, the power receiving coil being electrically connected to the battery; wherein
the power receiving coil has a frame shape along the frame portion, and is provided in the frame portion.

16: The unmanned aerial vehicle according to claim 15, wherein the rotation axis extends in a vertical direction.

17: The unmanned aerial vehicle according to claim 15, wherein the power receiving coil provides non-contact power feeding through a magnetic field resonance system.

18: The unmanned aerial vehicle according to claim 17, wherein a first central axis of the power receiving coil is inclined with respect to the vertical direction.

19: The unmanned aerial vehicle according to claim 15, wherein
a plurality of the frame portions are provided; and
the power receiving coil is provided in each of the plurality of the frame portions.

20: The unmanned aerial vehicle according to claim 15, further comprising a switching circuit that connects and short-circuits terminals of the motor in an ON state.

21: The unmanned aerial vehicle according to claim 15, wherein the frame portion has an annular shape.

22: The unmanned aerial vehicle according to claim 15, wherein
the frame portion is made of resin; and
the power receiving coil is embedded in the frame portion.

23: The unmanned aerial vehicle according to claim 15, wherein the frame portion includes:
a frame main body including a groove opening in one direction and accommodating the power receiving coil; and
a lid portion that is fixed to the frame main body and closes an opening of the groove.

24: An unmanned aerial vehicle system comprising:
the unmanned aerial vehicle according to claim 15; and
a power transmission device including a power transmission coil to provide non-contact power feeding, the power transmission coil being capable of transmitting electric power to the power receiving coil.

25: The unmanned aerial vehicle system according to claim 24, wherein an outer diameter of the power transmission coil is equal to or larger than a maximum dimension of the unmanned aerial vehicle.

26: The unmanned aerial vehicle system according to claim 25, wherein the outer diameter of the power transmission coil is at least twice as large as the maximum dimension of the unmanned aerial vehicle.

27: The unmanned aerial vehicle system according to claim 24, wherein in the power transmission coil:
a dimension in a first direction orthogonal to a second central axis of the power transmission coil is about 648 mm or smaller; and
a dimension in a second direction orthogonal to both the second central axis of the power transmission coil and the first direction is about 870 mm or smaller.

28: A battery system of an unmanned aerial vehicle, the unmanned aerial vehicle including:
a main body;
a propulsion assembly including a rotary blade and a motor to rotate the rotary blade about a rotation axis, the propulsion assembly being to be attached to the main body; and
a frame portion in a frame shape surrounding an outside of the rotary blade in a radial direction of the rotation axis;
the battery system comprising:
a rechargeable battery to supply electric power to the propulsion assembly; and
a power receiving coil to provide non-contact power feeding, the power receiving coil being electrically connected to the battery; wherein
the power receiving coil has a frame shape along the frame portion, and is provided in the frame portion.
